(19) United States
(12) Patent Application Publication
(10) Pub. No.: US 2022/0351916 A1
(43) Pub. Date: Nov. 3, 2022

(54) DYE-SENSITIZED SOLAR CELL WITH ZnO NANOROD-BASED PHOTOANODE

(71) Applicant: KING FAISAL UNIVERSITY, Al-Ahsa (SA)

(72) Inventors: FAHEEM AHMED, AL-AHSA (SA); MOHAMMED BENALI KANOUN, AL-AHSA (SA); SOURAYA GOUMRI-SAID, AL-AHSA (SA); MOUSAAB BELARBI, AL-AHSA (SA); NAGIH SHAALAN, AL-AHSA (SA); NISHAT ARSHI, AL-AHSA (SA); ABDULLAH ALJAAFARI, AL-AHSA (SA); ADIL ALSHOAIBI, AL-AHSA (SA)

(21) Appl. No.: 17/246,697

(22) Filed: May 2, 2021

(51) Int. Cl. H01G 9/20; H01G 9/00

(52) U.S. Cl. CPC H01G 9/204; H01G 9/0029; H01G 9/2059

(57) ABSTRACT

An electrode for a photovoltaic device such as a dye sensitized solar cell includes a uniform layer of ZnO nanorods formed on a transparent conductive substrate and a natural dye, such as pigments from a natural source like coffee, on the ZnO nanorods. A dye sensitized solar cell formed from the electrode as a working electrode and a carbon-based counter electrode, such as a carbon soot layer on a transparent conductive substrate. The electrode and dye sensitized solar cell are formed by a simple, cost effective, environmentally friendly and easily scalable method.

### BACKGROUND

### 1. Field

The disclosure of the present patent application relates to electrodes for a photovoltaic device. In particular, the present patent application relates to electrodes comprising natural dye and ZnO nanorods.

### 2. Description of the Related Art

Dye-sensitized solar cells (DSSCs) are photovoltaic devices that are cost-effective, easy to fabricate, and eco-friendly. In operation, DSSCs do not emit greenhouse gas and efficiently convert visible light into electrical energy. Development of low cost counter electrodes for use in DSSCs or other photovoltaic devices and applications are desired.

Many wide band gap semiconductors have been used in photoanodes for DSSC devices, such as zinc oxide (ZnO), niobium pentoxide (Nb₂O₅), tin dioxide (SnO₂), and titanium dioxide (TiO₂) nanoparticles. ZnO is considered an efficient photoanode because of its ability to endure constant electron transfer under sun light irradiation in the visible to ultraviolet range. ZnO nanostructures have been prepared in various forms (nanoparticles, nanorods, nanowires, nanosheets, etc.).

Dye plays a vital role in absorbing visible light and converting it into electricity in DSSCs. Commonly, synthetic dyes having good photoelectric conversion efficiency have been used as photosensitizers in DSSCs. However, synthesizing dyes is complicated, expensive, polluting, and potentially toxic. Natural dyes are abundant and easy to access safely. As such, several natural dyes have been tried as photosensitizers in DSSCs.

Counter electrodes in DSSCs are usually made of platinum (Pt), which is extremely expensive. Alternative materials or structures for counter electrodes are needed.

Thus, electrodes and methods of preparing electrodes for photovoltaic devices such as DSSCs solving the aforementioned problems is desired.

### SUMMARY

An embodiment of the present subject matter is an electrode for a photovoltaic device comprising a substrate layer, a ZnO nanorod layer on the substrate layer; and a natural dye on the ZnO nanorod layer.

Another embodiment is a dye sensitized solar cell (DSSC) comprising an electrode having a substrate layer, a ZnO nanorod layer on the substrate layer; and a natural dye on the ZnO nanorod layer and a counter electrode having a carbon-based conductive layer.

Still another embodiment of the present subject matter is a method for forming an electrode for a photovoltaic device comprising suspending ZnO nanorods in a solvent and a dispersive agent to form a slurry, applying the slurry to a substrate to form a uniformly thick ZnO nanorod layer, and applying a natural dye on the ZnO nanorod layer.

These and other features of the present subject matter will become readily apparent upon further review of the following specification.

### BRIEF DESCRIPTION OF THE DRAWINGS

FIG. 1 is a schematic diagram showing the assembly method of the present dye-sensitized solar cell (DSSC), including the fabrication methods of a ZnO-natural dye working electrode and a carbon-based counter electrode.

FIG. 2 depicts X-ray diffraction (XRD) patterns of the prepared ZnO nanorods.

FIGS. 3A-3B depict (A) transmission electron microscopy (TEM) images of the prepared ZnO nanorods, and (B) high-resolution TEM (HRTEM) image of the prepared ZnO nanorods, with the inset showing the corresponding selected area electron diffraction (SAED) pattern of the prepared ZnO nanorods.

FIG. 4 depicts the current density-voltage (J-V) characteristics curve obtained experimentally for the DSSC as well as theoretically for a modeled DSSC using parameters obtained from experimental data and a cell area of 1 cm².

FIGS. 5A-5B are plots showing the measured (A) fill factor and (B) efficiency, of the present DSSC as functions of ZnO film thickness.

Similar reference characters denote corresponding features consistently throughout the attached drawings.

### DETAILED DESCRIPTION OF THE PREFERRED EMBODIMENTS

An embodiment of the present subject matter is directed to an electrode for a photovoltaic device comprising a substrate layer, a ZnO nanorod layer on the substrate layer; and a natural dye on the ZnO nanorod layer. The substrate layer may include a transparent layer and a transparent conductive oxide layer on the transparent layer. In particular, the transparent layer may be glass and the transparent conductive oxide layer may be indium tin oxide. It should be understood, however, that other transparent conductive substrates may be used including other transparent conductive oxide-coated glass substrates.

The ZnO nanorod layer can include ZnO nanorods having a radius ranging from about 25 nm to about 80 nm and a length ranging from about 1 μm to about 2 μm. The ZnO nanorods may have an aspect ratio ranging from about 10 to about 80, e.g., from about 20 to about 30. The ZnO nanorods may be crystalline with hexagonal phase. In an embodiment, the natural dye comprises anthocyanins, which may be derived from a plant or plant product having naturally occurring anthocyanins, such as coffee, raspberries, or blueberries. The ZnO nanorods may form a uniform layer on the transparent conductive oxide layer having a thickness ranging from about 5 μm to about 40 μm, e.g., from about 8 μm to about 10 μm.

A dye sensitized solar cell (DSSC) can include the electrode and a counter electrode having a carbon-based conductive layer. The carbon-based conductive layer may be a layer of carbon soot and may have a uniform thickness ranging from about 1 μm to about 10 μm. The DSSC, also referred to herein as photovoltaic device, can efficiently convert visible light into electrical energy.

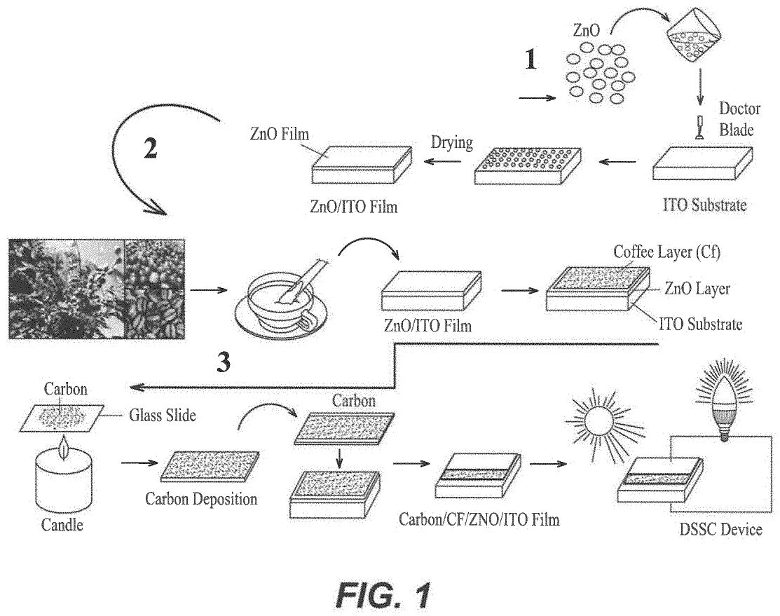

A method for forming an electrode for a photovoltaic device can include suspending ZnO nanorods in a solvent and a dispersive agent to form a slurry, applying the slurry to a substrate to form a ZnO nanorod layer having a uniform thickness, drying the ZnO nanorod layer, annealing the ZnO nanorod layer, and applying a natural dye to the ZnO nanorod layer. The natural dye can be provided by pigments from coffee. The coffee pigments are also referred to herein as “exemplary natural dye.” The uniform ZnO nanorod layer may be achieved by using a doctor blade. FIG. 1 is a schematic diagram illustrating the fabrication method of the ZnO-natural dye working electrode and the carbon-based counter electrode.

The amounts of materials for the methods described herein are exemplary, and appropriate scaling of the amounts are encompassed by the present subject matter, as long as the relative ratios of materials are maintained. As used herein, the term “about,” when used to modify a numerical value, means within ten percent of that numerical value. The following examples illustrate the present teachings.

### EXAMPLES

### Example 1

### Preparation of Working Electrode

All of the reagents involved in the experiments were of analytical grade and utilized as received without further purification.

An indium doped tin oxide (ITO) coated glass substrate was used as a base substrate for forming exemplary working electrodes. The ITO substrate, approximately 2 cm×2 cm, was cleaned and dried. A mold was formed on the ITO substrate by placing masking tape (1 mm-2 mm) on either side of the conductive side of the ITO substrate.

Zinc acetate (Zn(CH₃COO)₂.2H₂O; 99.999%) and sodium hydroxide (NaOH; 99.99%) were purchased from Sigma Aldrich. A solution was prepared having a 1:20 molar ratio of (Zn(CH₃COO)₂.2H₂O) to NaOH dissolved in 100 ml distilled water in a round-bottom flask. The solution was transferred into a 100 ml Teflon-lined digestion vessel and treated at a temperature of 160° C. for 20 min at a pressure of 100 psi in a microwave-hydrothermal system (CEM; MARS-5). The operating power used was 300 W and the temperature during irradiation was measured by a thermocouple placed in the reference vessel. The power, heating temperature, and reaction time values were continuously monitored during the preparation process. After microwave processing, the solution was cooled to room temperature. The resulting precipitate was separated by centrifugation, washed with deionized water and absolute ethanol several times, and finally dried in an oven at 80° C. for 24 h to produce ZnO nanorods. Well-controlled synthesis parameters, including solution concentration, reaction time, and reaction temperature might change the ZnO nanorod size and shape. In the present examples, synthesis parameters were optimized to keeping the target of high aspect ratio and well defined hexagon phase nanorods. In particular, the length and diameter of the exemplary ZnO nanorods were about 1 μm and 45 nm, respectively (aspect ratio ˜22).

A ZnO nanorod slurry or suspension was prepared under ambient conditions by grinding the as-prepared ZnO nanorods with ethanol using an agate mortar to avoid aggregation and to create a uniform distribution of ZnO nanorods. Two drops (approximately 0.06 mL each. 0.12 mL total) of Triton X100 was added as a surfactant to maintain smoothness in the paste. Specifically, the ZnO slurry was prepared by mixing 100 mg of ground ZnO nanorods to 1 mL of ethanol and ˜0.12 mL Triton X100.

A few drops (3-5 drops, i.e. 0.2-0.3 ml) of the ZnO suspension was cast onto a cleaned and dried ITO conductive glass substrate and distributed across the area of the mold with a doctor-blade. The coating was performed in one direction on the flat surface of the ITO conductive glass substrate. The ZnO nanorod coated ITO substrate was allowed to dry and then annealed at 550° C. for 1 hour under atmospheric conditions. The resulting ZnO nanorod layer was between 8-10 μm thick, depending on applied ZnO suspension, and was uniform in thickness and ZnO nanorod distribution (i.e., no aggregates or clumps formed).

The annealed ZnO nanorod coated ITO substrate was soaked in a coffee solution for 24 hours. To prepare the coffee solution, natural coffee (Nescafe®) was combined with distilled water (1 g/20 ml) at room temperature and stirred for 30 min to make a homogenous solution. Exemplary natural dye from the coffee attached to the surface of the ZnO nanorods by adsorption. Unreacted or non-attached exemplary natural dye was removed by washing with ethanol repeatedly, e.g., 3-5 times, to make sure that all unanchored coffee was removed.

### Example 2

### Fabrication of Exemplary DSSC Comprising the Exemplary Working Electrode

A second ITO coated glass was used to make a counter electrode. The conductive side of the second ITO was exposed to a candle flame, causing a thin layer of carbon to be deposited thereon. The flame was applied to the substrate for not more than 0.30 sec at any location at a time. Exposure in any one spot at a time for over 1 s could crack the ITO coated substrate. The coating was applied by repeated back and forth movement of the flame relative to the second ITO coated glass substrate for 2 minutes. The thickness of the resulting carbon coating was in the range of ˜5 μm and was very uniform all over the targeted surface (variations no more than 10%). There were no atmosphere requirements for this coating step, which was performed at room temperature. Carbon soot covered the conductive side of the second ITO coated glass substrate, while the other side remained reflective like a mirror.

The working electrode and the counter electrode were laid on top of each other, such that the ZnO layer and carbon layer faced each other. The electrodes were secured with binder clips to complete the DSSC assembly. A liquid electrolyte (iodide/tri-iodide) based solution was placed at the top of the conductive edge of the cell and allowed to fill the space between the two conductive electrodes by capillary action.

### Example 3

### Characterization of Exemplary Working Electrode and Exemplary DSSC

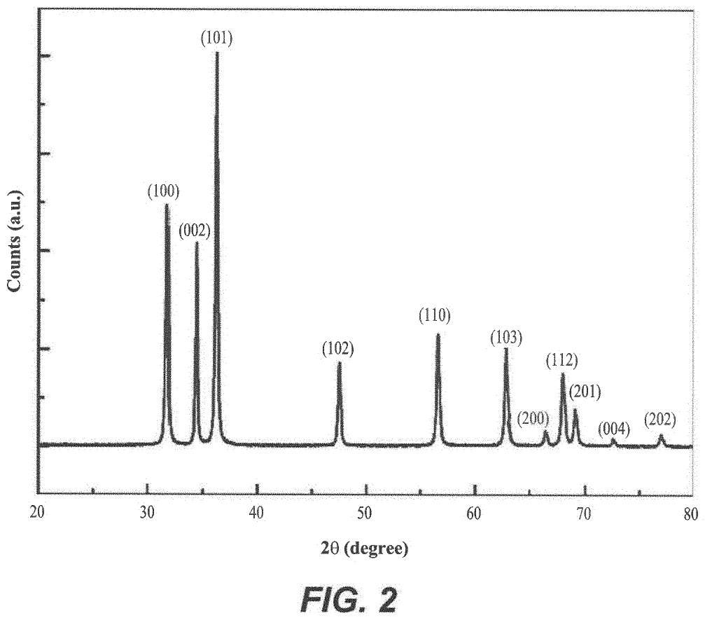

FIG. 2 shows the X-ray Diffraction (XRD) pattern of the ZnO nanorods prepared according to the present methods. All of the peaks in the observed XRD pattern are indexed to wurtzite ZnO structure, and are in close agreement with the standard data of JCPDS 89-1397. The high intensity of the peaks and the absence of any secondary phase further confirm the high crystalline quality of the as-prepared ZnO nanorods.

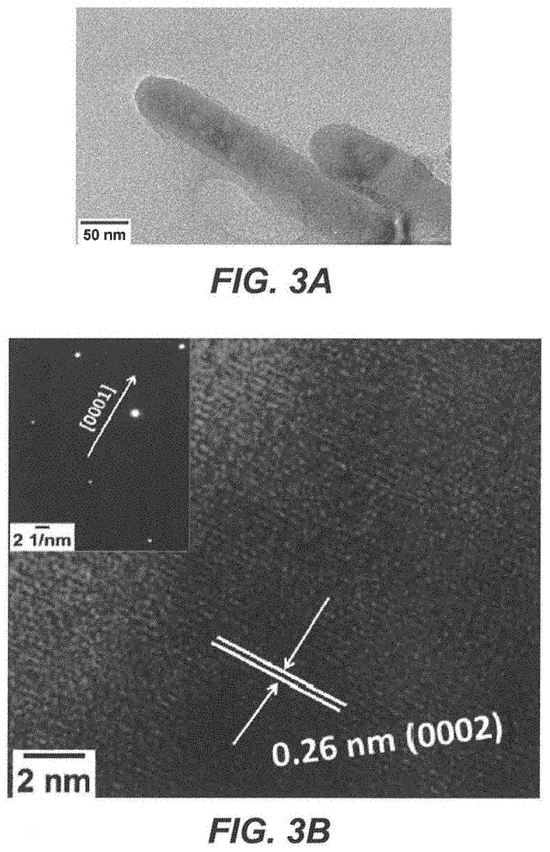

Morphological features and crystalline quality of ZnO nanorods were observed through transmission electron microscopy (TEM) imaging. FIG. 3A shows TEM images of ZnO nanorods prepared by the present method. The overall morphological features indicate ZnO nanorods having a length and diameter of ˜1 μm and ˜45 nm, respectively. The atomic structure was obtained from high resolution transmission electron microscopy (HRTEM) imaging. The HRTEM image shown in FIG. 3B depicts the highly crystalline nature of ZnO nanorods with an interlayer spacing of ˜0.26 nm, which corresponds to the d spacing of the (002) lattice plane in ZnO structures. The inset of FIG. 3B shows the selected area electron diffraction (SAED) patterns of the nanorods containing bright dot patterns correspond to single-crystal behavior of the as-prepared ZnO nanorods.

The as-prepared ZnO nanorods-based electrode exhibited a maximum power conversion efficiency (PCE) in the exemplary DSSCs of 0.54%, with an open circuit voltage (Voc) and short-circuit current density (Jsc) of 0.272 V, and 7.4 mA/cm², respectively. Significantly, the ZnO nanorods, electrodes and DSSCs fabricated as above may be produced at large scale using existing economical, biosafe, and highly effective DSSC fabrication techniques.

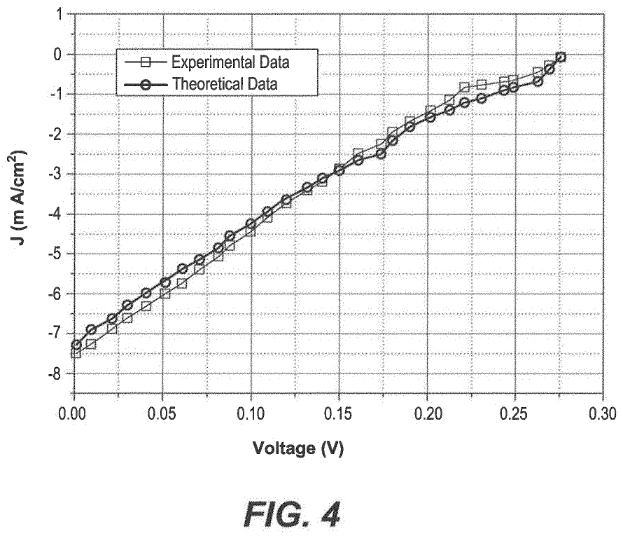

An enhanced computational model for simulating electrical properties of DSSCs was used to study the impact of physical parameters of the present exemplary DSSC cell on its J-V characteristic curve, performance and photovoltaic efficiency. The model confirmed experimental results regarding the I-V curves and efficiencies of the exemplary DSSC cell, as shown in FIG. 4. The model was used to demonstrate the impact of physical parameters on the operation mode of the as-prepared DSSC cells. These physical parameters were the thickness and morphology of the ZnO layer, the mobility of electrons and recombination rate (electron lifetime), the absorption spectrum of the dye, materials quality making the transparent conductive oxide (TCO) layers and their thickness effect. The thickness was assumed to be uniform, and the parameters were estimated to best match the as-prepared electrodes and DSSCs.

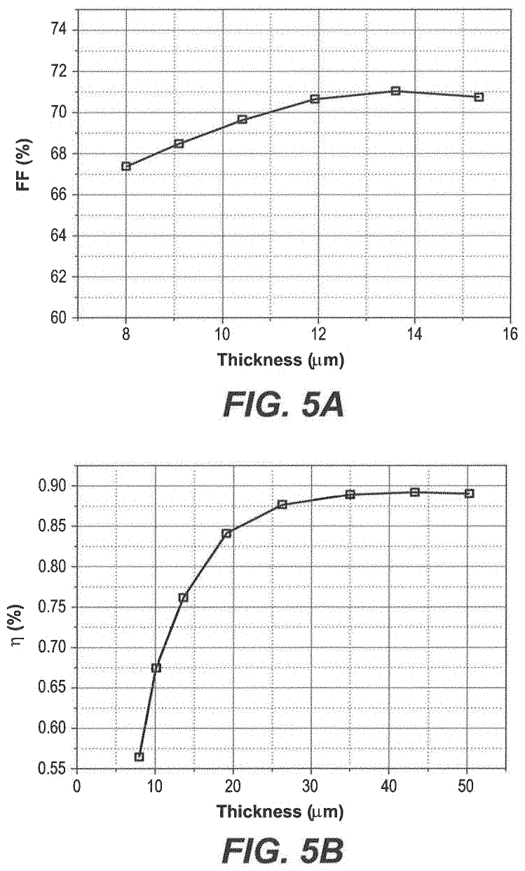

FIGS. 5A-5B show variation fill factor and efficiency as a function of ZnO film thickness according to the above simulations. In FIG. 5B, a larger range of thickness was simulated in order to see the effect on the performance of the solar cell and also extract the most optimum one to produce high efficiency. For the calculation of the efficiency, Pmax, Pi, Im, Vm, A and φ and were obtained from the I-V curve. In particular, it was found from the I-V curve: A=0.5 cm²=0.00005 m², φ=1000 W/m², t=8 μm, Pₘ=0.02823485 W.

The fill factor was determined in the simulation to be FF=66%, in good agreement with the experimental FFₑₓₚ=67.3886%. The efficiency of the cell was calculated by the following formula:

$${η}_{DSSC} = \frac{{P}_{max}}{{P}_{i}} = \frac{{I}_{m} {V}_{m}}{A φ} ,$$

leading to η=0.564697%, in good agreement with experimental data ηₑₓₚ=0.54%. It was shown from the simulation that an efficiency of 0.89% could be reached for a thickness of 30 μm.

It is to be understood that the present dye-sensitized solar cell and associated electrodes are not limited to the specific embodiments described above, but encompasses any and all embodiments within the scope of the generic language of the following claims enabled by the embodiments described herein, or otherwise shown in the drawings or described above in terms sufficient to enable one of ordinary skill in the art to make and use the claimed subject matter.

1. An electrode for a photovoltaic device, comprising:
a substrate layer;
a ZnO nanorod layer on the substrate layer, the ZnO nanorod layer comprising a plurality of nanorods; and
coffee pigments adsorbed from a homogenous coffee solution on the ZnO nanorods.

2. The electrode for a photovoltaic device of claim 1, wherein
the substrate layer includes a transparent layer and a transparent conductive oxide layer on the transparent layer; and
the ZnO layer is on the transparent conductive oxide layer.

3. The electrode of claim 2, wherein
the transparent layer is glass and the transparent conductive oxide layer is indium tin oxide.

4. The electrode of claim 1, wherein
the ZnO nanorods have a radius ranging from about 25 nm to about 80 nm and a length ranging from about 1 μm to about 2 μm.

5. The electrode of claim 1, wherein
the ZnO nanorods have an aspect ratio ranging from about 10 to about 80.

6. The electrode of claim 1, wherein
the ZnO nanorods have an aspect ratio ranging from about 20 to about 30.

7. The electrode of claim 1, wherein
the ZnO nanorods are crystalline with hexagonal phase.

8. (canceled)

9. (canceled)

10. (canceled)

11. The electrode of claim 1, wherein
the ZnO layer has a uniform thickness ranging from about 5 μm to about 40 μm.

12. A dye sensitized solar cell comprising the electrode of claim 1 as a working electrode.

13. The dye sensitized solar cell of claim 12, further comprising a counter electrode comprising
a counter substrate coated with a carbon-based coating.

14. The dye sensitized solar cell of claim 13, wherein the counter substrate includes a transparent layer and a transparent conductive oxide layer on one side of the transparent layer.

15. The dye sensitized solar cell of claim 14, wherein the carbon-based coating is carbon soot.

16. The dye sensitized solar cell of claim 14, wherein the carbon-based coating has a uniform thickness ranging from about 1 μm to about 10 μm.

17. A method for forming an electrode for a photovoltaic device comprising:
suspending ZnO nanorods in a solvent and a dispersive agent to form a slurry,
applying the slurry to a substrate to form a ZnO nanorod layer of uniform thickness;
drying the ZnO nanorod layer;
annealing the ZnO nanorod layer; and
applying a natural dye to the ZnO nanorod layer after annealing.

18. The method of claim 17, wherein
the ZnO nanorods have a radius ranging from about 25 to about 80 nm and a length ranging from about 1 μm to about 2 μm.

19. The method of claim 18, wherein
the ZnO nanorods are crystalline with hexagonal phase.

20. The method of claim 19, wherein
the natural dye comprises anthocyanins.

21. The dye sensitized solar cell of claim 14, wherein the dye sensitized solar cell has a maximum power conversion efficiency of 0.54%, an open circuit voltage of 0.272 V, and a short-circuit current density of 7.4 mA/cm².

22. The dye sensitized solar cell of claim 14, wherein the dye sensitized solar cell has a fill factor of 66% and an efficiency of η=0.5464697%.

23. The dye sensitized solar cell of claim 14, wherein the dye sensitized solar cell has an efficiency of 0.89% and a thickness of the ZnO nanorod layer is 30 μm.
